(19) United States
(12) Patent Application Publication
(10) Pub. No.: US 2004/0199422 A1
(43) Pub. Date: Oct. 7, 2004

(54) Consumer transaction-based marketing of goods and services

(76) Inventors: Larry Napier, Thompson Station, TN (US); Stuart Graham, Poway, CA (US)

Correspondence Address: WOOD, HERRON & EVANS, LLP, 2700 CAREW TOWER, 441 VINE STREET, CINCINNATI, OH, 45202, US

(21) Appl. No.: 10/607,677

(22) Filed: Jun. 27, 2003

Related U.S. Application Data
(60) Provisional application No. 60/460,015, filed on Apr. 3, 2003.

(51) Int. Cl. G06F 17/60

(52) U.S. Cl. 705/14; 705/35; 705/39

(57) ABSTRACT

A method and system for using free registration of branded network credit and debit cards to provide transaction-based marketing to merchants and businesses. For each purchase made using a registered credit or debit card at a registered merchant, a marketing fee related to the transaction amount is paid by the registered merchant. Commission fees are distributed from the marketing fee to the marketer(s) responsible for registering the merchant and to the marketer(s) responsible for registering the cardholder. In addition, usage fees may be paid to the marketer responsible for the sale or circulation of registered debit cards.

### CROSS REFERENCE TO RELATED APPLICATIONS

This application claims the benefit of U.S. Provisional Application No. 60/460,015, filed Apr. 3, 2003 and entitled “Consumer Transaction-Based Marketing Of Goods And Services.”

### FIELD OF THE INVENTION

The invention relates to a method for using free registration of branded network credit and debit cards and proprietary debit cards to provide transaction-based marketing to merchants and businesses.

### BACKGROUND OF THE INVENTION

Branded-network credit card issuers and direct credit card issuers commonly use accrual rebate programs in an attempt to entice use of their proprietary credit cards. In such accrual rebate programs, the card issuers establish the rules governing the rebates earned by cardholders. The rebates are only realized and received by the cardholder. Typically, rebates accumulate as a percentage of the cumulative transaction fees charged for electronic funds transfer. Periodically, the cardholder is eligible to receive a distribution of the cumulative transaction amounts as a cash value by either a credit account refund or a paper bank draft or by another award. For example, Discover card accumulates a percentage of the purchase price of individual purchases to a separate accrual account assigned to the cardholder and transfers the rebate from the accrual account to the cardholder's credit account.

Rebate accrual programs are usually transparent to the merchant and are generally a way for the card issuer to generate business for the card. The more cardholders that use the card with the rebate incentive, the more the card issuer will be able to encourage merchants to honor the card. Increasing the number of participating merchants generates additional transaction fees for the card issuer. As such, generally merchants receive nothing in exchange for honoring the card, except the advantage of credit/debit-based payments for purchases. Therefore, merchants must direct marketing and advertisement efforts elsewhere for promoting their goods and services.

Merchants may engage advertising and marketing agencies to promote goods and services for increasing consumer business. However, such marketing and advertising agencies are expensive. Moreover, merchants really have no convenient way to measure the effectiveness of the agency's marketing efforts. Merchants pay for the marketing efforts regardless of success or failure, with an option of engaging a different marketing agency for failed marketing efforts.

Many merchants utilize loyalty cards, rebates, coupons and merchandizing discounts as vehicles for attracting consumers. However, such conventional means of attracting customers are routine and have lost consumer appeal. They also require the customer to maintain additional cards or information associated with a myriad of different merchants. This does not entice the consumer and further complicates the process. Furthermore, each individual merchant incurs the expense of marketing and advertising their individual programs so that customers will engage and use such programs.

Small merchants often lack the financial resources to even hire professional marketing and advertising agencies and thereby realize the benefits of professional advertising. Internet-based businesses face the same issues regarding marketing effectiveness and cost as do bricks-and-mortar small businesses. Therefore, such small merchants often cannot participate on the level of larger companies.

Businesses often pay employees either with a paper check or by electronic deposit to an employee's account at a financial institution. Employees who lack an account at a financial institution cannot be paid electronically and must be paid by check. Such employees must use expensive check cashing services to obtain cash and purchase goods and services. International or domestic transfers of funds are transacted either by purchasing money orders and mailing them, or by using expensive funds wiring services. While payroll cards are known, there is currently no technique for converting or registering payroll cards for generating marketing fees, commission fees, or cardholder refunds.

For these reasons, it is desirable to provide a more effective transaction-based marketing system for promoting the goods and services of merchants.

### SUMMARY

The invention provides a method for marketing a merchant's goods and services where the cost of marketing is assessed after a purchase, sale or transaction. The method begins by the free registering of debit and credit cards of cardholders and registering EFT terminal accounts of participating merchants. The method further includes monitoring for purchases of goods and services at participating merchants and dispersing portions of per-transaction marketing fees paid by the merchants to marketers and cardholders.

In another aspect, the invention is directed to a method for obtaining transaction-based marketing of goods and services. The method comprises registering an EFT terminal account for accepting registered cards, accepting a registered card at the EFT terminal account for transacting a purchase of goods or services in a transaction amount, receiving payment of the transaction amount, and paying a marketing fee based upon the transaction amount for use in compensating a marketer who cause the registration of the EFT terminal account.

In another aspect, the invention is directed to a marketing method that includes registering a plurality of proprietary debit cards each carrying a cash value and distributing the plurality of debit cards to a plurality of individuals. The method further includes monitoring for transactions that reduce the cash value of any one of the plurality of debit cards and dispersing a usage fee after the transaction to a marketer responsible for the registration of the plurality of debit cards.

The free registration of branded network credit and debit cards to provide transaction-based marketing to merchants and businesses of the invention creates a new category of commerce for the global economy. The invention is designed to create a grass-roots-joint-venture-relationship between registered merchants and marketers who want to develop a “commission only” income stream by working as independent sales representatives for registered merchants. The invention creates a previously unavailable advertising and marketing system for global businesses and services both online and off, and a constant flow of income for marketers. In effect, the invention creates a new economic model for the global economy.

The invention differs from conventional accrual rebates paid to cardholders by credit/debit card issuers that promote use of the credit/debit cards themselves. Conventional accrual rebates are accumulated and dispersed to the cardholder's account periodically as a rebate check or an account credit. In accordance with the principles of the invention, consumer refunds are not accumulated but, instead, are credited for each qualifying transaction directly to the consumer's account maintained by the issuer of the credit or debit card. Moreover, conventional accrual rebates do not reward the merchant for participation, except for the advantages of accepting credit cards as part of a non-cash payment system. Instead and in accordance with the principles of the invention, a portion of each transaction amount is paid as compensation to marketers for branding, promoting and advertising the merchant's goods and services. Conventional rebates are paid from a portion of the standard transaction fee paid to the issuer by the merchant for each credit/debit transaction. Registered merchants pay a marketing fee that funds payment of the marketer's compensation only if the marketing efforts of the marketer successfully induce a purchase of goods or services made by a cardholder using a registered card at the registered merchant.

In accordance with the principles of the invention, the merchant or business receives branding, promoting and advertising of its goods and services with little or no additional cost to the merchant. In particular, the merchant does not have to purchase and install any equipment or software and does not have to train either management or employees. The mechanism that deducts marketing fees from the transaction amounts and distributes the marketers' compensation and consumer refunds is incorporated into the electronic funds transfer infrastructure and is transparent to the merchant at the point-of-sale. The principles of the invention provide marketing of goods and services to both large businesses and businesses that cannot afford to engage a costly advertising agency.

The principles of the invention are effective for promoting the goods and services of businesses having an Internet presence in addition to a conventional storefront, or for promoting the goods and services of businesses that transact business exclusively via the Internet. In particular, marketing fees may be readily captured for Internet transactions if payment is made using proprietary debit cards of the invention. Future technology may allow marketing fees to be paid regardless of how payment, such as by branded credit or debit cards, is made for on-line purchases transacted over the Internet.

In accordance with the principles of the invention, funds that the registered merchant or business would have otherwise spent for loyalty cards, rebates, coupons and merchandizing discounts and funds that the merchant would have used to hire commercial marketing organizations are diverted to directly reward marketers for branding, promoting and advertising the merchant's goods and services. The compensation paid to the marketer represents a fraction or proportion of the transaction amount. The invention provides a convenient and an economical alternative to traditional advertising as no up-front money is required and the burdens associated with traditional advertising are eliminated. Merchants do not have to increase the price of goods or services to offset the marketing expenses as a marketing fee is assessed only if a registered card is used to transact a purchase.

These and other objects and advantages of the present invention shall become more apparent from the accompanying drawings and description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the details of the preferred embodiments.

FIG. 1 is a logic flow diagram illustrating transaction-based marketing in accordance with the principles of the invention;

FIG. 2 is a schematic diagram illustrating the operation of the transaction-based marketing system of the invention;

FIG. 3 is a schematic diagram illustrating the flow of funds in accordance with the principles of the invention; and

FIG. 4 is a schematic diagram illustrating the operation of an aspect of the transaction-based marketing system of the invention.

### DETAILED DESCRIPTION OF THE INVENTION

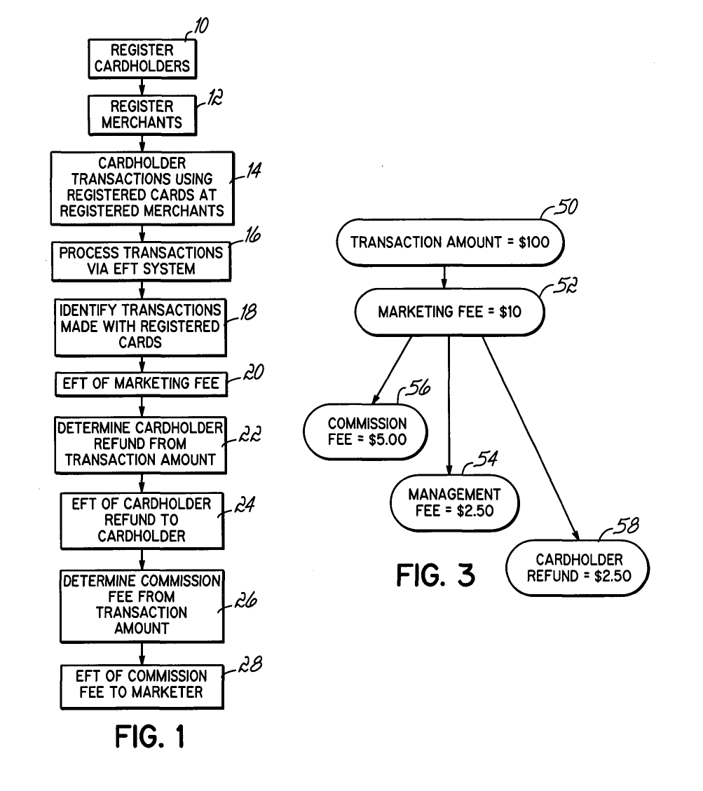

With reference to FIG. 1, one aspect of the invention is directed to a transaction-based marketing system for branding, advertising, promoting and marketing the goods or services characteristic of the merchant that relies on registered card technology. In block 10, independent marketers solicit cardholders of existing credit cards and debit cards, who are also consumers of goods and services, to register at least one of their cards with an administrative service provider. The marketers may be individuals, individuals associated in a hierarchal structure, a marketing organization, an affinity group or an entity. Affinity groups may cause their members to register their existing credit and debit cards. Card registration may be accomplished in a number of different ways including, for example, registration over the Internet or registration by paper application.

Any existing credit or debit card may be registered in the marketing system of the invention regardless of the issuer or branded network. This is a significant advantage to the invention. Branded networks that issue cards capable of being registered include, but are not limited to, Visa, MasterCard, Discover and American Express. Proprietary cards that are not branded may be registered, as well as any proprietary card or ancillary identifier that is associated with an underlying branded credit or debit card. To participate by registering a card with the marketing system, a cardholder does not have to apply for a credit line or be approved by a financial institution to obtain a new credit card because only their existing credit cards are registerable. Furthermore, the marketing system of the invention eliminates the need for a merchant-specific card or merchant-specific information to be carried and handled by the consumer.

The administrative service provider maintains a registered card database containing records relating to the registered cards, including card number and the cardholder identity. Each credit or debit card is obtained from a third party issuer and the cardholder has a cardholder account established at the third party issuer that is associated with the credit or debit card. The administrative service provider does not issue the card but, instead, accepts registration of existing cards. The administrative service provider operates as a clearinghouse, as will be explained herein, for all card transactions. Therefore, registered cards do not have to bear any additional information or contain any encoded data, other than the account number, identifying the cards to the administrative service provider or a registered merchant as being registered cards. Moreover, the marketing system does not require the association of any supplemental identification codes for identifying the registered cards, unless the registered card has a pre-existing identifier from a third party. This eases the burden on cardholders, as noted, who do not have to carry additional cards or remember any particular code or other merchant-specific information.

As shown in block 12, independent marketers also solicit merchants to register the merchant's credit card processing identification number, which may be associated with several EFT terminal accounts, with the administrative service provider. The credit card processing identification number is assigned by, and associated with, the merchant's merchant processor so that the merchant processor can identify credit/debit card files transmitted to it by that merchant. The merchant processor and the administrative service provider each maintain a merchant database containing records relating to each merchant, including the credit card processing identification number. Individual merchants may have a storefront, may also have Internet sales, or may sell exclusively via the Internet. As described below, signing up the merchants provides part of the overall marketing effort and creates a revenue stream for the marketer. Participating merchants are identified to the cardholders of registered cards by a merchant participation indicator, such as a sign or insignia, visible at a store entrance or a symbol visible on a web page.

Using registered card technology, the administrative service provider matches transactions made at registered merchants with the registered cards used to transact those purchases to identify qualifying transactions that trigger payment of a marketing fee. The administrative service provider reports qualifying transactions to a database management entity. An exemplary administrative service provider that commercially provides registered card technology is Card Commerce International, Inc. (Los Angeles, Calif.).

In accordance with one aspect of the invention, participating merchants agree to pay the marketing fee in exchange for cardholder solicitation efforts and other advertising and marketing efforts by the marketers. The marketing fee is set at or before the merchant is registered as a participant. In one embodiment, the amount of the marketing fee paid by participating merchants may be computed by a standardized approach as a percentage of each transaction amount and determined based on the specific goods and services sold by the merchant. Therefore, the marketing fee percentage may be uniform among all participating merchants selling identical or substantially similar types of goods and/or providing identical or substantially similar types of services. For example, the marketing fee percentage paid by participating merchants may be based upon the standardized classes of goods as defined by Standard Industrial Classification (SIC) codes so that merchants and marketers cannot mutually negotiate a different marketing fee percentage, but rather the merchant's goods alone will determine such percentage. It follows that the marketing fee percentage may be uniform for specific merchant types and that merchant participation may be solicited on a “take-it-or-leave-it” basis. In an alternative embodiment, the marketing fee percentage for participating merchants may be determined individually by negotiation. As such, participating merchants may be permitted to determine the marketing fee percentage on an individual merchant-by-merchant basis rather than on a uniform standardized basis, as described above.

In accordance with one aspect of the invention, marketers provide branding, promoting and advertising of a registered merchant's goods and services with negligible additional cost to the merchant. This allows smaller merchants to receive specific marketing resources and services similar to those that larger companies now utilize. The merchant has no upfront hard cost for such advertising and marketing, does not have to purchase and install any equipment or software, and does not have to train management or employees to implement the transaction-based marketing system of the invention. Marketing fees and consumer refunds are distributed from commission fees in cooperation with the conventional infrastructure that accomplishes electronic funds transfers in the normal course of business. The mechanism is transparent to the merchant. The merchant does not have to be concerned with accounting for the amounts of the deducted marketing fees. In short, the merchant only pays a marketing fee based on those sales of goods and services that are associated with successful marketing efforts that cause the transaction to occur.

In block 14, cardholders represent consumers that present registered cards at the time and place of sale to transact purchases of goods and services at the registered merchants. The debit or credit card bears a magnetic stripe carrying an account number for the cardholder's credit or debit account. The invention contemplates that the registered card is not limited to current state of the art identification technique but may include any identification system that could be used to identify and facilitate electronic funds transfer (EFT) for payment at a merchant location. For example, an identification number linked to the registered card may be encoded into an embedded chip on the hand, forehead or any other part of the human body that is readable electronically by the merchant. Other identification systems include fingerprints, retinal scans, energy fields, or other personal recognition system that may be involved prospectively in EFT credit/debit payments.

Branding and marketing generate sales for registered merchants. For example, registered cardholders are more likely to purchase goods and services with registered cards at registered merchants rather than other non-registered merchants, who may be direct competitors of the registered merchants. This is because transactions made with registered cards result in direct cardholder refunds. Cardholders can readily identify registered merchants because of the presence of the merchant participation indicator and elect to purchase goods and services from the registered merchant. A print or electronic listing of registered merchants may be made available to the cardholders for their reference in locating registered merchants. This may be part of the marketing efforts to benefit merchants, along with any other advertising listing the registered merchants in an area. The listing provides registered cardholders with a guide to registered merchants in a particular city or locale and facilitates usage for promoting the goods and services of the registered merchants.

Registered merchants do not have to perform any affirmative act at the time and point of sale, such as obtaining and inputting an independent identifier associated with either the card or the cardholder, in order to qualify transactions made using a registered card. As a result, transacting the qualifying purchases is simplified, the speed of the sale is increased versus other incentive programs, bookkeeping of the transaction amounts is not required, and the cardholder merely has to present the registered card for payment in order to activate the marketing fee system.

In block 16, transactions made at registered merchants are processed by the electronic funds transfer (EFT) system for a variety of different card issuers and their associated branded cards as is done in the normal course of business. Registered merchants route credit/debit card files for all transactions, regardless of whether individual purchases were made with registered or non-registered cards, to the merchant processor for settlement of funds by electronic funds transfer. As payment for the transaction, the merchant processor instructs the issuing authority of the credit/debit card to initiate an EFT of the transaction amount (less any applicable fees paid to the issuer or to the branded network) from the cardholder's account associated with or accessed by the issuer to the merchant's account at the merchant's financial institution. The EFT may transfer the transaction amount using either the Automated Clearing House (ACH) Debit method for debit cards or the ACH Credit method for credit cards.

In block 18 and in accordance with the principles of the invention, the merchant processor also forwards all credit/debit card files to the administrative service provider pursuant to agreement with the registered merchant. This is in contrast to conventional rebate accrual programs that are controlled by the card issuer and that merely supply the cardholder with a rebate from the card issuer for using branded cards. The administrative service provider identifies transactions made at registered merchants by comparison of the transmitter of the credit/debit card files with a database containing the identity of each registered merchant. From among all transactions made at the registered merchants, the administrative service provider identifies those transactions that were made using registered cards at registered merchants listed in the registered merchant database. Therefore, the process is a two-step process of identifying registered merchants and identifying transactions made using registered cards at those registered merchants. The administrative service provider forwards all credit/debit card files in the two-step process without the direct involvement of the merchant.

As noted in block 20, the administrative service provider initiates an EFT of the marketing fee from the merchant's account at the merchant's financial institution to a designated account at another financial institution, referred to herein as a holding financial institution. This marketing fee provides the marketing incentive associated with the invention and designates the beginning of the flow of funds to various entities in accordance with the principles of the invention.

Next, referring to block 22, the administrative service provider determines a refund for each individual transaction that will be credited to the registered cardholder's account that is linked to the credit or debit card. The refund originates from the marketing fees transferred to the designated account at the holding financial institution. The amount of each refund is determined as a percentage of the corresponding transaction amount. As noted further below, the refund back to the registered cardholder is generally immediate. Therefore, the refund is essentially realized as a reduction in the purchase price for the transaction. The refund amounts are not accumulated in a separate cardholder account and are not transferred to the cardholder at regular spaced intervals, on certain occasions, or otherwise upon demand by the cardholder. Rather, when the transaction occurs, a refund will result without accrual. In addition, the refunds are not related to fees deducted from the transaction amount that are paid to the merchant processor or to the branded network for settlement of funds.

In block 24, the administrative service provider initiates an EFT of the refund amount from the designated account at the holding financial institution to the registered cardholder's account at the issuer of the credit or debit card. Because the funds are electronically transferred, the registered cardholder does not have to take any affirmative action to initiate the transfer. If the cardholder uses a credit card to purchase the goods or services, the refund amount is applied for reducing the registered cardholder's credit card liability. If the cardholder uses a debit card to purchase the goods or services, the cash value of the refund amount is restored to the registered cardholder's debit card account. The purchase and refund are separate transactions and will generally appear as such on a cardholder's statement. However, they will generally occur close to the same time, such as on the same day or a day or two apart.

This lack of accrual in a separate account and immediate refund provide numerous advantages over conventional accrual rebate systems. In particular, neither the merchant nor the card issuer has to maintain a separating accounting of the refunds. Moreover, the cardholder does not have to carry or be cognizant of any information other than the registered card itself, does not have to make any decisions regarding the refunds, and does not have to interact with the system to obtain the refund or to request account information.

The administrative service provider forwards credit/debit card files for transactions made using registered cards at registered merchants to a database management entity. The database management entity is responsible for determining compensation to marketers and apportioning payment of commission fees to individual marketers, in accordance with aspects of the invention. Commission fees are payable to one or more marketers responsible for registration of the merchant and to one or more marketers responsible for registration of the cardholder.

In accordance with another inventive aspect, as noted in block 26, the database management entity determines commission fees or compensation payable to one or more marketers from the credit/debit card files of qualifying transactions. To that end, the database management entity may also track hierarchical relationships among multiple different levels of marketers in a marketing organization. In accordance with another aspect of the invention, the commission fees for each qualifying transaction come directly from the marketing fee that has been captured from the merchant without the merchant's direct involvement. Therefore, the merchant pays nothing for marketing unless and until a transaction occurs that is associated with the marketing effort. The burden of the marketing success or failure lies with the marketers. Any successes are readily apparent to the merchant as qualifying transactions are easily tracked. Each marketing fee is determined as a percentage of the corresponding transaction amount of the individual transactions. In one embodiment, the commission fee, along with the refund amount, are each percentages of the marketing fee. As the awarding of marketer's compensation is transaction-based, there is no ceiling or cap on the cumulative commission fees received over time by each marketer.

The marketers promote the goods or services of the registered merchant and encourage use of registered cards for increasing the effectiveness of the transaction-based marketing system in accordance with the invention. Marketers may use multi-level marketing principles to recruit and enlist subordinate marketers to establish a tiered hierarchical structure among multiple different marketers. Increased usage of the system increases compensation payable to the marketer. Therefore, the marketers are motivated to promote use of the registered cards, to promote registered merchants and their goods and services, and to enlist additional marketers.

In block 28, the database management entity pays the commission fees from the designated account at the holding financial institution to the marketer. The payment may be electronic funds transfer to a financial institution account associated with each relevant marketer or by another payment method. Marketers may be individuals or any hierarchal structure of individuals. A marketer may solicit an affinity group for registering branded credit or debit cards of its membership for whom the affinity group already has the pertinent card information or for encouraging a constituent base of members to register their existing branded credit and debit cards. The distribution of the commission fees generates a previously non-existent consumer income stream.

The commission fees may be distributed to the marketer(s) using a network or multi-level marketing commission structure as understood by persons of ordinary skill in the art. Specifically, a portion of the commission fee may be distributed to three or more levels of members in a marketing organization or team who have recruited, trained and motivated the card-registering and/or merchant-registering sales force of marketers. Multi-level marketing encourages current independent marketers to recruit new independent marketers, who can register cards and/or merchants and recruit additional marketers. Marketers are not only paid for merchants and/or cardholders that they register, but also for merchants and/or cardholders registered by new marketers they recruit and by new marketers recruited by their recruits. By offering such multi-level sponsorship, the number of marketers is increased significantly.

In accordance with one aspect of the invention, manufacturer discounts, similar in effect to conventional coupons, passed on to the consumer by a registered merchant as a reduction in the prices of goods and products may trigger the capture of item-specific marketing fees. Specifically and as is conventional, every good or produce is identified by a unique Stock Keeping Unit (SKU), usually alphanumeric, that allows it to be tracked for inventory purposes. When a cardholder transacts a purchase of goods or products with a registered card, the SKU's of the purchased goods are captured by the registered merchant. The registered merchant transfers those SKU's to the administrative service provider and/or the database management company, where a database of SKU's for specific goods and products eligible for manufacturer discounts is maintained. Purchases of eligible goods and products are detected and trigger an EFT of an amount equal to the manufacturer discount from the merchant's account at the merchant's financial institution to the designated account at the holding financial institution. The manufacturer discount is treated as a marketing fee from which refunds and commission fees are distributed as consumer income to more than three to marketers, as described above, and program management fees may be withheld by the database management company.

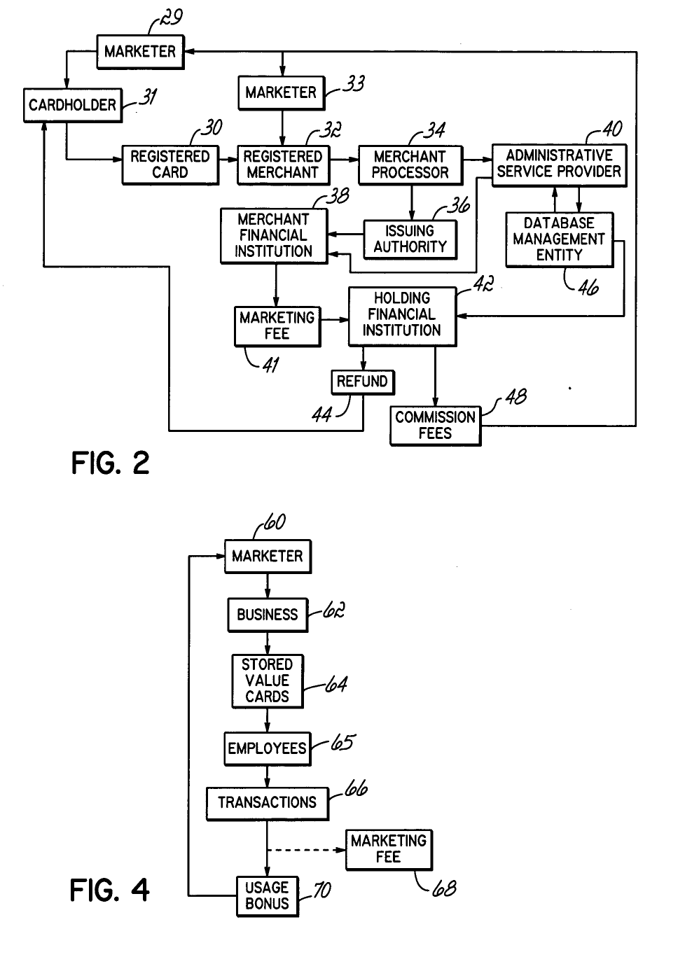

With reference to FIG. 2, the operation of the marketing system in accordance with one embodiment of the invention will be described diagrammatically. A marketer 29 solicits a cardholder 31 to register a card 30 with the marketing system. Similarly, a marketer 33, who may be the same as marketer 29, causes a merchant 32 to register a merchant identification number with the marketing system. The cardholder presents a registered card 30 to transact a purchase of goods or services at the registered merchant 32. As is conventional, the registered merchant 32 transmits credit/debit files to the merchant processor 34, who instructs the issuing authority 36 of the registered card 30 to electronically transfer the transaction amount from the cardholder's account to the merchant's account at a merchant's financial institution 38.

The merchant processor 34 also sends the credit/debit files received from the merchant to an administrative service provider 40. In a two-step process, the administrative service provider 40 identifies transactions made at registered merchants 32 and, from among those transactions, identifies transactions made with registered cards 30 at registered merchants 32. The administrative service provider 40 initiates an EFT of the marketing fee 41 for each individual transaction from the merchant's account at the merchant's financial institution 38 to a designated account at a holding financial institution 42. The administrative service provider 40 determines a refund 44 for each individual transaction and initiates an EFT of the amount of refund 44 from the designated account at a holding financial institution 42 to a cardholder 46 that presented the registered card 30 to the registered merchant 32.

The administrative service provider 40 forwards credit/debit files of qualifying transactions made using registered cards 30 at registered merchants 32 to a database management entity 46. The database management entity 46 determines the payable commission fees 48 and distributes the commission fees 48 from the designated account at the holding financial institution 42 to the appropriate marketer or marketers 29, 33. The database management entity 46 may also receive a management fee deducted from the marketing fee for recruiting, training and motivating the card-registering and/or merchant-registering marketer.

With reference to FIG. 3, an example of the flow of funds in accordance with the principles of the invention is illustrated diagrammatically. In block 50, a cardholder makes a purchase of goods or services at a registered merchant, as such, in a representative transaction amount of $100. After electronic funds settlement between the merchant and issuing authority of the card, a representative marketing fee of 10 percent of the transaction amount, or $10, is transferred electronically by EFT from the account of the merchant to a designated holding account in block 52. Therefore, the net effect is that the merchant retains $90 of the transaction amount, less any fees paid to the merchant processor. From the representative marketing fee, a representative management fee of $2.50 is retained in the designated holding account for compensating a management entity directing the activities of the marketer in block 58 as a cardholder refund. Also, from the representative marketing fee, a representative commission fee of $5.00 is transferred electronically by EFT from the designated holding account to the marketer's account or multiple marketer accounts in block 56. The $5.00 commission fee might also be broken down to other individual accounts based on other embodiments of the invention. For example, a portion of the $5.00 commission fee may go to an entity that signed up or registered the cardholder. Another portion may go to the entity that registered the merchant, and so on. The commission fee can be broken down even further as desired to other entities. Finally, from the representative marketing fee, a representative refund of $2.50 is transferred electronically by EFT from the designated holding account to the cardholder's account in block 58. This will reduce the $100 transaction amount effective to $97.50. For this representative fee schedule, the marketing fee is 10 percent of the transaction amount, the management fee is 25 percent of the marketing fee, the commission fee is 50 percent of the marketing fee, and the cardholder refund is 25 percent of the marketing fee. It is appreciated that the described flow of funds is not intended to be limiting of the invention but instead is illustrative of the principles of the invention.

In accordance with the principles of the invention and with reference to FIG. 4, businesses may pay employees with private-issued, payroll or stored-value cards. A marketer 60 solicits the participation of a business 62. The participating business 62 funds an account at a private issuer with the total cash value of a group of stored-value cards 64. The stored-value cards 64 are issued by the private issuer through a branded network, such as MasterCard or Visa. The cash value held by each stored-value card 64 is equal to the salary or compensation of one of the business's employees 65. The stored-value cards 64 are pre-registered in the marketing system of the invention, as described above.

The stored-value cards 64 are distributed by the business 62 to its employees 65. The employees 65 make transactions 66, such as obtaining cash from the stored-value cards by a cash withdrawal at an automated teller machine (ATM) or purchasing goods or services at any merchant with the stored-value cards. When an employee 65 obtains cash or makes a purchase, each transaction 66 is processed through the electronic funds transfer (EFT) system, as described herein, and the cash value of the stored-value card 64 is decremented by the amount of each transaction 66. If the employee 65 transacts a purchase of goods and services at a merchant registered in the marketing system of the invention, the merchant pays a marketing fee 68. As described above, a portion of the marketing fee 68 is distributed as a commission fee to the marketer who registered the merchant identification number of the merchant at which the transaction 66 was made and another portion of the marketing fee is distributed as a refund to the cash value account funding the stored-value card 66 of the employee 65 making the purchase.

The private issuer of the stored-value cards 64 may elect to pay a usage fee or bonus 70 as a branding incentive to the marketer 60 that solicited the participation of the business 62 to distribute the pre-registered stored-value cards 64. Each time that one of the stored-value cards 64 is used to make a transaction 66, the usage bonus 70 is paid to the marketer 60 who enrolled the business 62. The usage bonuses 70 are not based upon the transaction amounts but, instead, usage bonuses represent additional funds that the marketing system pays directly to the marketer 60. Usage bonuses 70 may vary among different states of residence of the marketer 60. Usage bonuses 70 paid to the marketer 60 are independent of marketing fees 68 paid by registered merchants. No portion of the usage bonus 70 is paid to the employee holding the stored-value card 64. This generates another previously non-existent stream of consumer income and encourages use of the branded stored-value cards 64.

The marketing system benefits employees that lack an account at a financial institution. If paid according to the principles of the invention with stored-value cards, employees that lack, or are otherwise unable to obtain, an account can obtain cash and purchase goods and services from the cash value stored on the stored-value card without using a check cashing service and without purchasing money orders. In addition, employees lacking accounts can transfer funds from the cash value stored on the stored-value card nationally and internationally without purchasing money orders or using a funds wiring service. Employees having accounts benefit due to the cost savings of not having to purchase the stored-value card to obtain its benefits. The participating business gains the benefit of not incurring the costs associated with cutting conventional payroll checks and distributing those conventional payroll checks to the employees. This lowers the business's payroll costs. The participating business also gains employee goodwill.

In yet another aspect of the invention, a marketer may also sell or circulate proprietary debit cards issued by a private issuer through a branded network. Each time that one of the debit cards is used for a transaction to purchase goods or services or to consummate a cash withdrawal, a usage bonus, as described above, is paid to the marketer who sold or was responsible for the circulation of the debit card. Moreover, the debit cards are registered with the marketing system of the invention before sale or circulation. As a result, transactions made with the pre-registered debit cards at registered merchants produce a stream of consumer income in the form of marketing fees paid by the registered merchant and commission fees payable to the marketer responsible for registration of the participating merchant, as described herein.

In yet another aspect of the invention, either pre-registered proprietary debit cards, registered debit cards, or registered credit cards may be used to transact Internet purchases. The marketing system of the invention supplies a method for accurately and simply tracking transactions for purposes of commission payments to marketers. Specifically, the Internet merchant is registered by a marketer with the marketing system. Payments for goods or services transacted using registered cards with the registered Internet merchant are processed and generate marketing fees of which portions are payable to one or more marketers, as described above.

In yet another aspect of the invention, an affinity group may arrange for its members or subscribers to sell proprietary debit cards issued by a private issuer through a branded network to consumers. Each time that one of the debit cards is used for a transaction at any merchant, a usage bonus, as described above, is paid to the marketer who sold or was responsible for the obtaining the participation of the affinity group. Moreover, the debit cards are registered with the marketing system of the invention before sale or circulation. As a result, transactions made with the pre-registered debit cards at registered merchants produce a stream of consumer income in the form of marketing fees paid by the registered merchant and commission fees payable to the marketer responsible for registration of the participating merchant, as described herein. The affinity group also receives a portion of the marketing fee, which provides the affinity group with a participation incentive.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants' general inventive concept.

The scope of the invention itself should only be defined by the appended claims, wherein we claim:

1. A method of marketing goods and services of a merchant comprising:
registering a card of a cardholder;
registering a merchant identification number of a participating merchant;
monitoring for use of the registered card at the participating merchant for transacting a purchase of goods or services in a transaction amount; and
dispersing a commission fee based upon the transaction amount to a marketer of the participating merchant's goods and services.

2. The method of claim 1 further comprising:
determining a marketing fee in proportion to the transaction amount.

3. The method of claim 2 further comprising:
determining a refund amount from the marketing fee based upon the transaction amount;
deducting the refund amount from the marketing fee; and
transferring the refund amount to the cardholder.

4. The method of claim 2 wherein dispersing the marketing fee further comprises:
determining the commission fee from the marketing fee based upon the transaction amount;
deducting the commission fee from the marketing fee; and
transferring the commission fee to the marketer.

5. The method of claim 1 wherein monitoring for use of the card is performed without direct involvement by the participating merchant.

6. The method of claim 1 wherein dispersing the commission fee is performed without direct involvement by the participating merchant.

7. The method of claim 1 wherein dispersing the commission fee further comprises:
distributing a portion of the commission fee to the marketer as compensation for causing the registration of the card.

8. The method of claim 1 wherein dispersing the commission fee further comprises:
distributing a portion of the commission fee to the marketer as compensation for causing the registration of the merchant identification number.

9. The method of claim 8 wherein dispersing the commission fee further comprises:
distributing a portion of the commission fee to a different marketer as compensation for causing the registration of the card.

10. The method of claim 1 wherein the marketer is recruited, trained and motivated by a marketing team having at least three levels of members, and dispersing the commission fee further comprises:
distributing a portion of the marketing fee to the marketing team.

11. The method of claim 1 further comprising:
dispersing a usage fee to an account associated with a different marketer for use of the registered card.

12. The method of claim 11 wherein the usage fee is paid as a branding bonus to the different marketer.

13. The method of claim 1 wherein the card is selected from the group consisting of a branded credit card, a branded debit card, a branded stored-value card, and a proprietary debit card.

14. The method of claim 1 wherein the registered card is used to transact a purchase of goods having a price reduction, and further comprising:
dispersing a portion of the price reduction to the marketer as compensation for causing the registration of the card.

15. The method of claim 1 wherein the registered card is used to transact a purchase of goods having a price reduction, and further comprising:
dispersing a portion of the price reduction to the marketer as compensation for causing the registration of the merchant identification number.

16. The method of claim 1 wherein the registered card is used to transact a purchase of goods having a price reduction, and further comprising:
dispersing a portion of the price reduction to the cardholder as a refund for transacting the purchase of goods having the price reduction.

17. A method for obtaining transaction-based marketing of goods and services comprising:
registering a merchant identification number;
accepting a registered card for transacting a purchase of goods or services in a transaction amount;
receiving payment of the transaction amount; and
paying a marketing fee based upon the transaction amount for a transaction made with the registered card in which the marketing fee is used in compensating a marketer who caused the registration of the merchant identification number.

18. The method of claim 17 wherein paying the marketing fee is performed without direct involvement by a holder of the merchant identification number.

19. The method of claim 17 further comprising:
receiving marketing services performed by the marketer in exchange for payment of the marketing fee.

20. The method of claim 19 wherein receiving marketing services is free of direct involvement by a holder of the EFT terminal account.

21. The method of claim 17 wherein the marketing fee is determined according to a standardized approach according to a merchant classification.

22. The method of claim 21 wherein the merchant classification is standardized by an SIC coding system.

23. The method of claim 17 wherein the marketing fee is negotiated on a merchant-by-merchant basis.

24. The method of claim 17 wherein registered technology is used to determine if a registered card is used to transact the purchase as the registered merchant, and the merchant can negotiate the marketing fee.

25. The method of claim 17 wherein the registered card is selected from the group consisting of a branded credit card, a branded debit card, a branded stored-value card, and a proprietary debit card.

26. The method of claim 17 wherein the marketing fee is further used in compensating a different marketer who caused the registration of the registered card.

27. The method of claim 17 wherein the registered card is used to transact a purchase of goods having a price reduction, and further comprising:
paying the price reduction in which a portion of the price reduction is subsequently dispersed to a different marketer as compensation for causing the registration of the card.

28. The method of claim 17 wherein the registered card is used to transact a purchase of goods having a price reduction, and further comprising:
paying the price reduction in which a portion of the price reduction is subsequently dispersed to the marketer as compensation for causing the registration of the merchant identification number.

29. The method of claim 17 wherein the registered card is used to transact a purchase of goods having a price reduction, and further comprising:
paying the price reduction in which a portion of the price reduction is subsequently dispersed to the cardholder as a refund for transacting the purchase of goods having the price reduction.

30. A marketing method comprising:
registering a plurality of debit cards each carrying a cash value;
distributing the plurality of debit cards to a plurality of individuals;
monitoring for a transaction that reduces the cash value of any one of the plurality of debit cards; and
dispersing a usage fee after the transaction to a marketer responsible for the registration of the plurality of debit cards.

31. The method of claim 30 wherein the marketer receives the usage fee in exchange for causing the card distribution.

32. The method of claim 30 wherein the individuals are employees of a business, and further comprising:
registering the business to distribute the debit cards to the employees.

33. The method of claim 30 further comprising:
registering a merchant identification number of a participating merchant; and
dispersing a commission fee for transactions made at the participating merchant based upon the reduction in the cash value of the debit card to a different marketer responsible for registering the merchant identification number.

34. The method of claim 30 wherein the individuals are members of an affinity group, and further comprising:
registering the affinity group to distribute the debit cards to the members.
